(19) United States
(12) Patent Application Publication
(10) Pub. No.: US 2013/0139858 A1
(43) Pub. Date: Jun. 6, 2013

(54) SUBSTRATE CLEANING APPARATUS

(71) Applicant: Tokyo Ohka Kogyo Co., Ltd., Kawasaki-shi (JP)

(72) Inventor: Futoshi Shimai, Kawasaki-shi (JP)

(73) Assignee: TOKYO OHKA KOGYO CO., LTD., Kawasaki-shi (JP)

(21) Appl. No.: 13/687,936

(22) Filed: Nov. 28, 2012

(30) Foreign Application Priority Data
Dec. 1, 2011 (JP) 2011-263562

(51) Int. Cl. B08B 3/12

(52) U.S. Cl. CPC B08B 3/123
USPC 134/147; 134/137

(57) ABSTRACT

A substrate cleaning apparatus includes a transport section that transports a substrate in a predetermined direction, and an ultrasonic oscillation section that can clean the front surface side of the substrate by applying ultrasonic waves to the back surface of the substrate which is transported in the predetermined direction by the transport section. The ultrasonic oscillation section includes a liquid supply section that brings liquid into contact with the back surface of the substrate by surface tension, and a vibrator that applies ultrasonic vibrations to the liquid.

### BACKGROUND OF THE INVENTION

1. Field of the Invention

The present invention relates to a substrate cleaning apparatus.

Priority is claimed on Japanese Patent Application No. 2011-263562, filed on Dec. 1, 2011, the content of which is incorporated herein by reference.

2. Description of Related Art

A glass substrate for a liquid crystal display device has a TFT array formed in the same process as a semiconductor integrated circuit. Such a TFT array is patterned by using a resist film which is formed by baking a resist liquid coated on the glass substrate. Before a resist liquid coating process, a cleaning treatment to remove dirt or foreign matter from the front surface of the glass substrate is required. As an apparatus that performs such cleaning, a technique is known for performing cleaning of a substrate by applying ultrasonic waves to cleaning water that is supplied to the front surface of the substrate, from the back surface side of the substrate (refer to, for example, Japanese Unexamined Patent Application, First Publication No. 2005-13960).

### SUMMARY OF THE INVENTION

However, in the related art described above, since irradiation of ultrasonic waves is performed using an ultrasonic oscillation nozzle, irradiation of ultrasonic waves cannot be performed in a wide range of the back surface of the substrate, and thus provision of a new technique capable of more efficiently cleaning a substrate is desired.

The present invention has been made in view of such a problem and has an object of providing a substrate cleaning apparatus in which it is possible to efficiently perform cleaning.

In order to achieve the above object, according to a first aspect of the invention, a substrate cleaning apparatus is provided, including: a transport section that transports a substrate in a predetermined direction; and an ultrasonic oscillation section that can clean a front surface side of the substrate by applying ultrasonic waves to a back surface of the substrate which is transported in the predetermined direction by the transport section, wherein the ultrasonic oscillation section includes a liquid supply section that brings liquid into contact with the back surface of the substrate by surface tension, and a vibrator that applies ultrasonic vibrations to the liquid.

According to the substrate cleaning apparatus related to the first aspect of the invention, the ultrasonic vibrations can be applied through the liquid which comes into contact with the back surface of the substrate by surface tension. Accordingly, since the ultrasonic vibrations are propagated to the front surface side of the substrate over a wide range corresponding to a contact area of the liquid, it is possible to efficiently clean the front surface and the back surface of the substrate.

Further, in the substrate cleaning apparatus according to the first aspect described above, it is preferable that the liquid supply section bring the liquid that overflows from a liquid accommodation section accommodating the liquid into contact with the back surface of the substrate by the ultrasonic vibrations of the vibrator.

According to this configuration, the liquid overflows from the liquid accommodation section, whereby the ultrasonic vibrations can be stably applied to the back surface of the substrate.

Further, in the substrate cleaning apparatus according to the first aspect described above, it is preferable that the liquid supply section include a liquid circulation mechanism that circulates the liquid which has come into contact with the substrate to the liquid accommodation section.

According to this configuration, since the liquid is circulated by the liquid circulation mechanism, it is possible to reuse the liquid.

Further, in the substrate cleaning apparatus according to the first aspect described above, it is preferable that a plurality of vibrators be provided on an inner surface of the liquid accommodation section along a width direction intersecting a transport direction of the substrate and adjacent vibrators be disposed such that the respective end portions overlap in a direction intersecting an array direction in a plane of the inner surface.

That is, in the substrate cleaning apparatus according to the first aspect described above, it is preferable that the vibrators be respectively disposed on inner surfaces of a plurality of liquid accommodation sections along a width direction intersecting a transport direction of the substrate and the respective end portions overlap in a direction intersecting the array direction in the plane of the inner surface.

In another aspect of the substrate cleaning apparatus according to the first aspect described above, it is preferable that the vibrators be respectively disposed on inner surfaces of a plurality of liquid accommodation sections along a width direction intersecting a transport direction of the substrate and disposed such that the respective end portions of the vibrators overlap in a direction intersecting the array direction in the plane of the inner surface. In addition, in another aspect of the substrate cleaning apparatus according to the first aspect described above, it is preferable that the vibrators be respectively disposed on inner surfaces of a plurality of liquid accommodation sections along a width direction intersecting a transport direction of the substrate and disposed such that the respective end portions of the vibrators come into contact with each other in a direction intersecting the array direction in the plane of the inner surface.

According to this configuration, since adjacent vibrators are disposed in the liquid accommodation section such that the respective end portions overlap in the array direction, seams of areas where ultrasonic vibrations by an ultrasonic element are generated can be eliminated, and thus the ultrasonic vibrations can be applied uniformly over the width direction of the substrate.

Further, in the substrate cleaning apparatus according to the first aspect described above, it is preferable that the liquid supply section bring the liquid into contact with the entire area in a width direction intersecting a transport direction of the substrate.

According to this configuration, since the liquid comes into contact with the entire area in the width direction of the back surface of the substrate, the ultrasonic vibrations can be efficiently applied over the entire area in the width direction of the front surface of the substrate.

Further, in the substrate cleaning apparatus according to the first aspect described above, it is preferable that the substrate cleaning apparatus further include a front surface side cleaning section that cleans the front surface of the substrate by supplying cleaning liquid to the front surface side of the substrate and also removing the cleaning liquid along a direction intersecting a transport direction of the substrate.

According to this configuration, foreign matter removed from the front surface of the substrate by the ultrasonic vibrations can be removed by the cleaning liquid supplied to the front surface.

Further, in the substrate cleaning apparatus according to the first aspect described above, it is preferable that the front surface side cleaning section include a cleaning liquid supply section that supplies the cleaning liquid, and a regulation section that removes the cleaning liquid from the substrate by regulating the flow of the cleaning liquid along a direction intersecting the transport direction.

According to this configuration, generation of a defect in which the cleaning liquid that has cleaned the front surface of the substrate flows in the transport direction of the substrate can be prevented.

Further, according to a second aspect of the invention, a substrate cleaning apparatus is provided, including: a transport section that transports a substrate in a predetermined direction; and a front surface side cleaning section that cleans a front surface of the substrate by supplying cleaning liquid to the front surface side of the substrate and by also removing the cleaning liquid along a direction intersecting a transport direction of the substrate.

According to the substrate cleaning apparatus related to the second aspect of the invention, foreign matter can be removed over the entire area in a width direction intersecting the transport direction of the substrate by the cleaning liquid supplied from the front surface of the substrate by the front surface side cleaning section. Accordingly, foreign matter on the front surface of the substrate can be efficiently removed.

Further, in the substrate cleaning apparatus according to the second aspect described above, it is preferable that the front surface side cleaning section include a cleaning liquid supply section that supplies the cleaning liquid, and a regulation section that removes the cleaning liquid from the substrate by regulating the flow of the cleaning liquid along a direction intersecting the transport direction.

According to this configuration, generation of a defect in which the cleaning liquid that has cleaned the front surface of the substrate flows in the transport direction of the substrate can be prevented by the regulation section.

Further, in the substrate cleaning apparatus according to the second aspect described above, it is preferable that the substrate cleaning apparatus further include an ultrasonic oscillation section that can clean the front surface side of the substrate by applying ultrasonic waves to a back surface of the substrate in which cleaning is performed by the front surface side cleaning section while being transported in the predetermined direction by the transport section and the ultrasonic oscillation section includes a liquid supply section that brings liquid into contact with the back surface of the substrate by surface tension, and a vibrator that applies ultrasonic vibrations to the liquid.

According to this configuration, it is possible to apply the ultrasonic vibrations, by the ultrasonic oscillation section, to a wide range corresponding to a contact area of the liquid with respect to the front surface side of the substrate through the liquid which comes into contact with the back surface of the substrate by surface tension.

Accordingly, the front surface of the substrate can be efficiently cleaned in combination with the front surface side cleaning section.

Further, in the substrate cleaning apparatus according to the second aspect described above, it is preferable that the liquid supply section bring the liquid that overflows from a liquid accommodation section accommodating the liquid into contact with the back surface of the substrate by the ultrasonic vibration of the vibrator.

According to this configuration, the liquid overflows from the liquid accommodation section, whereby the ultrasonic vibrations can be stably applied to the back surface of the substrate.

Further, in the substrate cleaning apparatus according to the second aspect described above, it is preferable that the liquid supply section include a liquid circulation mechanism that circulates the liquid which has come into contact with the substrate to the liquid accommodation section.

According to this configuration, since the liquid is circulated by the liquid circulation mechanism, it is possible to reuse the liquid.

Further, in the substrate cleaning apparatus according to the second aspect described above, it is preferable that the vibrators be respectively disposed on inner surfaces of a plurality of liquid accommodation sections along a width direction intersecting a transport direction of the substrate and the respective end portions overlap in a direction intersecting an array direction in a plane of the inner surface.

That is, in the substrate cleaning apparatus according to the second aspect described above, it is preferable that a plurality of vibrators be provided on the inner surface of the liquid accommodation section along a width direction intersecting a transport direction of the substrate and adjacent vibrators be disposed such that the respective end portions overlap in a direction intersecting the array direction in the plane of the inner surface.

In another aspect of the substrate cleaning apparatus according to the second aspect described above, it is preferable that a plurality of vibrators be provided on the inner surface of the liquid accommodation section along a width direction intersecting the transport direction of the substrate and adjacent vibrators be disposed such that the respective end portions of the plurality of vibrators overlap in a direction intersecting the array direction in the plane of the inner surface. In addition, in another aspect of the substrate cleaning apparatus according to the second aspect described above, it is preferable that a plurality of vibrators be provided on the inner surface of the liquid accommodation section along a width direction intersecting the transport direction of the substrate and adjacent vibrators be disposed such that the respective end portions of the plurality of vibrators come into contact with each other in a direction intersecting the array direction in the plane of the inner surface.

According to this configuration, since the vibrators are disposed in the liquid accommodation section such that the respective end portions overlap in the array direction, seams of areas where ultrasonic vibrations are generated by an ultrasonic element can be eliminated, and thus the ultrasonic vibrations can be applied uniformly over the width direction of the substrate.

Further, in the substrate cleaning apparatus according to the second aspect described above, it is preferable that the liquid supply section bring the liquid into contact with the entire area in a width direction intersecting the transport direction of the substrate.

According to this configuration, since the liquid comes into contact with the entire area in the width direction of the back surface of the substrate, it is possible to efficiently apply the ultrasonic vibrations over the entire area in the width direction of the front surface of the substrate.

According to the invention, cleaning can be efficiently performed.

### BRIEF DESCRIPTION OF THE DRAWINGS

FIG. 1 is a schematic diagram showing the configuration of a substrate treatment apparatus.

FIG. 2 is an enlarged view of a main section showing the configuration of an ultrasonic cleaning section.

FIG. 3A is a diagram showing a plurality of vibrators disposed on the inner surface of a liquid accommodation section.

FIG. 3B is a diagram showing the plurality of vibrators disposed on the inner surface of the liquid accommodation section.

FIG. 4 is a diagram for explaining an operation of the ultrasonic cleaning section.

### DETAILED DESCRIPTION OF THE INVENTION

Hereinafter, an embodiment of the invention will be described with reference to the drawings.

In each of the following drawings, in describing the configuration of a coating apparatus related to this embodiment, for simplicity of expression, directions in the drawing will be described using an XYZ coordinate system. In the XYZ coordinate system, the left-and-right direction in the drawing will be denoted as an X direction and a direction perpendicular to the X direction in a plan view will be denoted as a Y direction. A direction perpendicular to a plane which includes an X direction axis and a Y direction axis will be denoted as a Z direction. Each of the X direction, the Y direction, and the Z direction will be described with a direction of an arrow in the drawing set to be a + direction and with an opposite direction to the direction of an arrow set to be a − direction.

Hereinafter, an example related to a substrate treatment apparatus with a substrate cleaning apparatus according to the invention applied thereto will be described.

The following substrate treatment apparatus is used when performing cleaning (hereinafter referred to as initial cleaning) before carrying in a resist coater with respect to a glass substrate for a liquid crystal display device to coat, for example, a resist material.

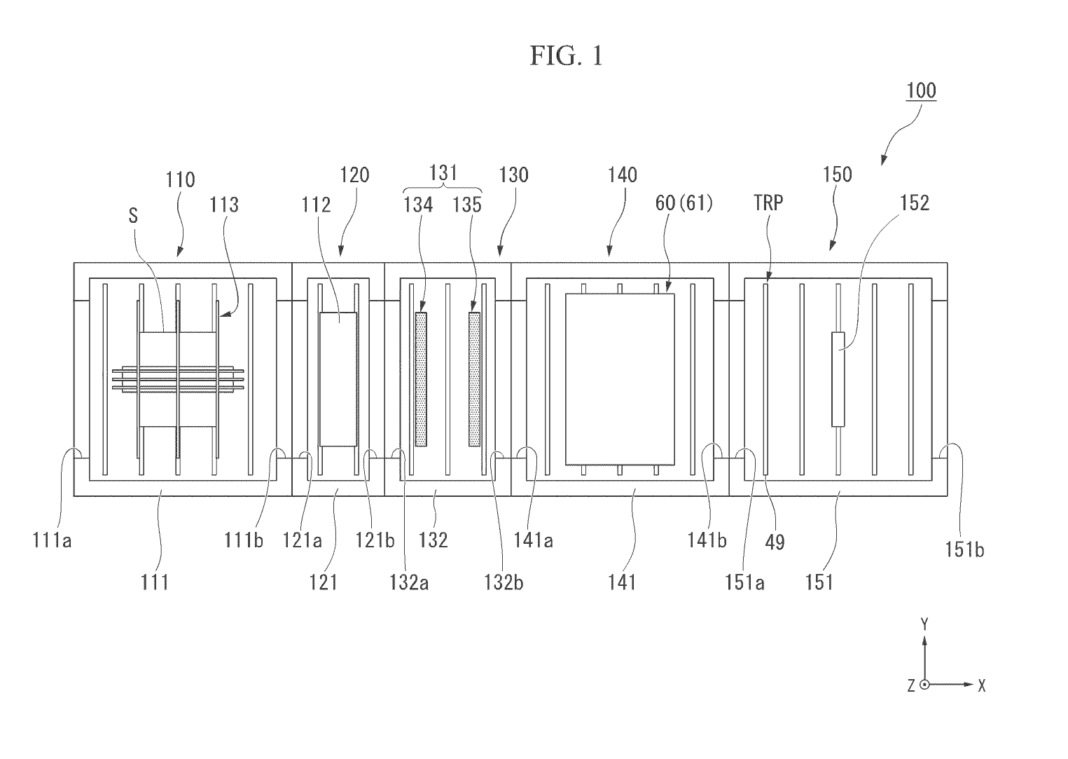

FIG. 1 is a plan view showing the configuration of a substrate treatment apparatus 100 related to this embodiment.

As shown in FIG. 1, the substrate treatment apparatus 100 includes an alignment section 110, a UV treatment section 120, a brush section 130, an ultrasonic cleaning section 140, and an air knife section 150.

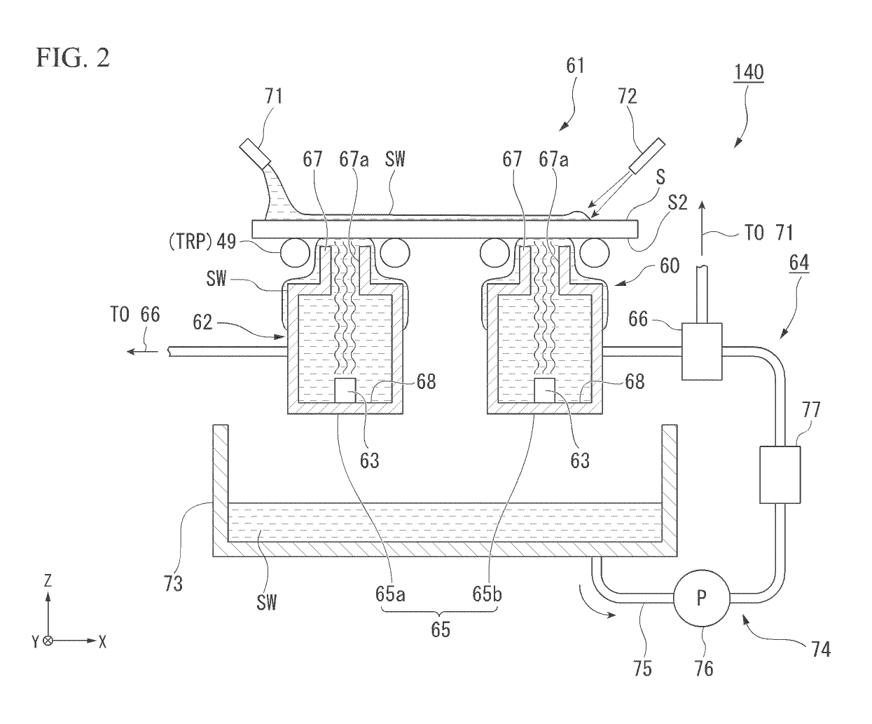

In the substrate treatment apparatus 100, a substrate S is transported between the respective configurations (the alignment section 110, the UV treatment section 120, the brush section 130, the ultrasonic cleaning section 140, and the air knife section 150) by a transport mechanism TRP (refer to FIG. 2) having a plurality of transport rollers 49. Each of the transport rollers 49 is made such that rotation is controlled by, for example, a roller rotation control section (not shown). As the transport mechanism, for example, a roller transport mechanism may be used and a flotation transport mechanism (not shown) that raises and transports a substrate may also be used.

The alignment section 110 has an accommodation chamber 111 that accommodates the substrate S, a substrate carrying-in port 111a, and a substrate carrying-out port 111b. In the accommodation chamber 111, each of the substrate carrying-in port 111a and the substrate carrying-out port 111b is formed to a size which the substrate S can pass therethrough. The substrate carrying-in port 111a is formed in a wall portion on the −X side of the accommodation chamber 111 and connected to, for example, a cartridge (not shown) that accommodates the substrate S. The substrate carrying-out port 111b is formed in a wall portion on the +X side of the accommodation chamber 111.

An alignment mechanism 113 is provided in the accommodation chamber 111. The alignment mechanism 113 has contact pins which come into contact with at least three locations of end portions of four corners in the substrate S having, for example, an approximately rectangular shape. In this way, the alignment mechanism 113 can adjust (align) the position of the substrate S carried in the substrate treatment apparatus 100 by bringing the contact pins into contact with end portions of the substrate S.

The UV treatment section 120 has an accommodation chamber 121, an ultraviolet irradiation section 122, a substrate carrying-in port 121a, and a substrate carrying-out port 121b. In the accommodation chamber 121, each of the substrate carrying-in port 121a and the substrate carrying-out port 121b is formed to a size which the substrate S can pass therethrough. The substrate carrying-in port 121a is formed in a wall portion on the −X side of the accommodation chamber 121 and the substrate carrying-out port 121b is formed in a wall portion on the +X side of the accommodation chamber 121.

The ultraviolet irradiation section 122 is provided in the accommodation chamber 121. The ultraviolet irradiation section 122 is for irradiating the substrate S with ultraviolet rays (UV light) and is constituted by, for example, a high-pressure mercury lamp. The UV treatment section 120 is made so as to remove organic matter adhered to the substrate S by performing irradiation of ultraviolet rays.

In the UV treatment section 120, when the ultraviolet irradiation section 122 performs irradiation of ultraviolet rays, leakage of ultraviolet rays from the inside of the accommodation chamber 121 is prevented by blocking the substrate carrying-in port 121a and the substrate carrying-out port 121b.

The brush section 130 has a cleaning brush 131, an accommodation chamber 132, a substrate carrying-in port 132a, and a substrate carrying-out port 132b. In the accommodation chamber 132, each of the substrate carrying-in port 132a and the substrate carrying-out port 132b is formed to a size which the substrate S can pass therethrough. The substrate carrying-in port 132a is formed in a wall portion on the −X side of the accommodation chamber 132 and the substrate carrying-out port 132b is formed in a wall portion on the +X side of the accommodation chamber 132.

The cleaning brush 131 that cleans the front surface of the substrate S is provided in the accommodation chamber 132. The cleaning brush 131 includes an upstream-side brush section 134 and a downstream-side brush section 135. The upstream-side brush section 134 is disposed on the upstream side in a transport direction of the substrate S and the downstream-side brush section 135 is disposed on the downstream side in the transport direction of the substrate S.

Each of the upstream-side brush section 134 and the downstream-side brush section 135 is constituted by a pair of brush rollers pinching the substrate S in the up-and-down direction (the Z direction). The brush roller is constituted, for example, by spirally implanting nylon brush bristles into a roller main body along an axial direction of the roller main body.

The brush roller is made such that the brush bristles come into contact with the front surface of the substrate S which is transported by the transport mechanism and remove foreign matter from the front surface of the substrate S by sweeping power thereof. The rotation direction of the brush roller is set to be a clockwise direction, that is, the opposite direction to the transport direction of the substrate S. Further, each brush roller is made so as to be movable in the up-and-down direction and made such that the pushing depths of the brush bristles of each brush roller with respect to the substrate S are controlled. In this way, damage to the substrate S due to a load that is applied to the substrate S by the brush roller which has come into contact with the substrate S is prevented.

The ultrasonic cleaning section 140 is constituted by an aspect of the substrate cleaning apparatus according to the invention. The ultrasonic cleaning section 140 includes an accommodation chamber 141, a substrate carrying-in port 141a, a substrate carrying-out port 141b, a first cleaning section 60, and a second cleaning section (a front surface side cleaning section) 61. The ultrasonic cleaning section 140 is for cleaning the substrate S by applying ultrasonic waves to the substrate S.

In the accommodation chamber 141, each of the substrate carrying-in port 141a and the substrate carrying-out port 141b is formed to a size which the substrate S can pass therethrough. The substrate carrying-in port 141a is formed in a wall portion on the +X side of the accommodation chamber 141. The substrate carrying-out port 141b is formed in a wall portion on the −X side of the accommodation chamber 141.

The detailed description of the ultrasonic cleaning section 140 will be described later. In this embodiment, a configuration in which the brush section 130 and the ultrasonic cleaning section 140 are respectively provided with the accommodation chambers 131 and 141 has been described. However, the accommodation chambers 131 and 141 may also be communalized between the brush section 130 and the ultrasonic cleaning section 140.

The air knife section 150 has an accommodation chamber 151, a blowing section 152, a substrate carrying-in port 151a, and a substrate carrying-out port 151b. In the accommodation chamber 151, each of the substrate carrying-in port 151a and the substrate carrying-out port 151b is formed to a size which the substrate S can pass therethrough. The substrate carrying-in port 151a is formed in a wall portion on the +X side of the accommodation chamber 151. The substrate carrying-out port 151b is formed in a wall portion on the −X side of the accommodation chamber 151 and connected to a resist treatment apparatus which performs resist treatment on the substrate S after the initial cleaning.

The blowing section 152 for blowing air to the front surface of the substrate S, thereby drying the front surface of the substrate S wetted due to cleaning by the ultrasonic cleaning section 140, is provided in the accommodation chamber 151.

FIG. 2 is an enlarged view of a main section showing the configuration of the ultrasonic cleaning section 140. In FIG. 2, in order to simplify the drawing, the illustrations of the accommodation chamber 141, the substrate carrying-in port 141a, and the substrate carrying-out port 141b are omitted.

As shown in FIG. 2, the first cleaning section 60 includes a cleaning liquid supply section (a liquid supply section) 62 that supplies cleaning liquid (liquid) to a back surface S2 of the substrate S, a vibration section (an ultrasonic oscillation section) 63 that applies ultrasonic vibrations to the cleaning liquid, and a cleaner circulation mechanism (a liquid circulation mechanism) 64 that circulates the cleaning liquid with respect to the cleaning liquid supply section 62.

The cleaning liquid supply section 62 has a liquid accommodation section 65 and a cleaning liquid supply section (a liquid supply section) 66, wherein the liquid accommodation section 65 is formed in a box shape, the liquid accommodation section 65 is disposed so as to face the back surface S2 of the substrate S and the liquid accommodation section 65 stores cleaning liquid SW, and a cleaning liquid supply section 66 supplies the cleaning liquid SW to the inside of the liquid accommodation section 65. As the cleaning liquid SW, it is preferable to use pure water, hydrogen water, ozone water, alkaline ionized water, or the like, and if the temperature is in a range of 40° C. to 50° C., molecules move faster, thereby causing activation, whereby a cleaning effect is improved.

The liquid accommodation section 65 may be configured with a plurality of liquid accommodating containers. For example, in FIG. 2, the liquid accommodation section 65 includes a first liquid accommodating container 65a and a second liquid accommodating container 65b. The first liquid accommodating container 65a and the second liquid accommodating container 65b are constituted in the same shape, and each of the first liquid accommodating container 65a and the second liquid accommodating container 65b has a convex portion 67 protruding to the +Z direction side and is disposed at a position where the cleaning liquid SW can come into contact with the back surface S2 of the substrate S by surface tension through an opening 67a formed in the convex portion 67. Further, the convex portion 67 of each of the first liquid accommodating container 65a and the second liquid accommodating container 65b is formed in a state where the width thereof in the X direction is narrowed compared to the other portion, and disposed in a state of being inserted between the transport rollers 49 of the substrate transport mechanism TRP.

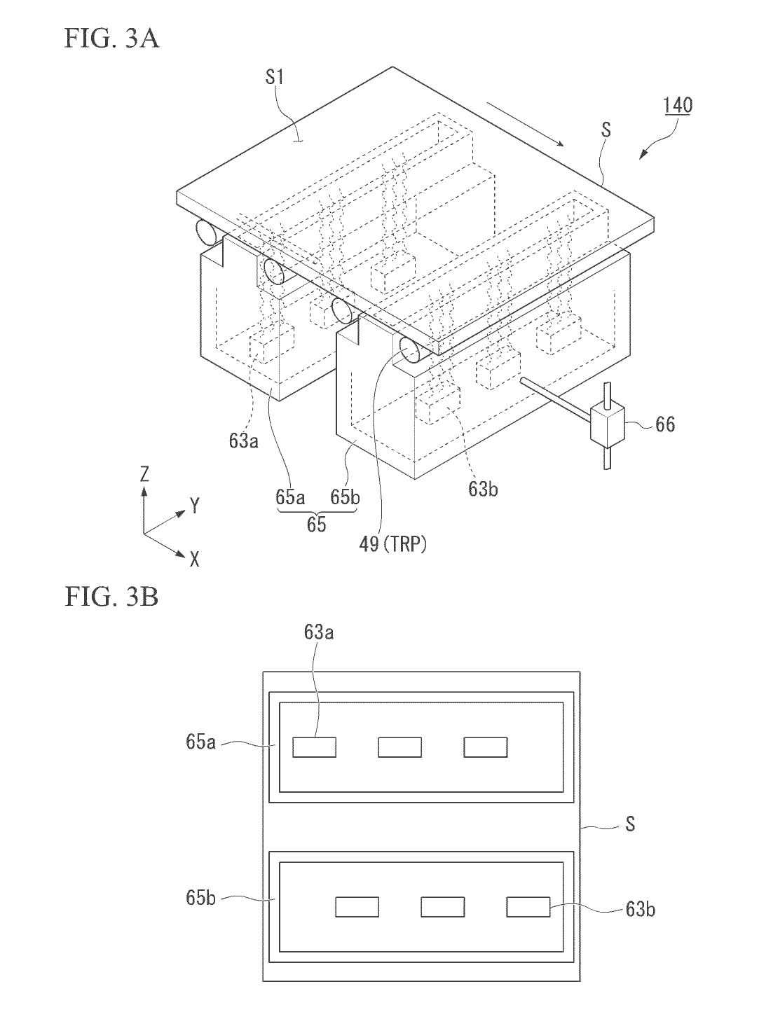

The width in the Y direction of the opening 67a formed in the convex portion 67 is constituted to be larger than the width in a direction (the Y direction) intersecting the transport direction of the substrate S, and thus the cleaning liquid SW can come into contact with the entire area in the width direction of the back surface S2 of the substrate S (refer to FIG. 3A).

Specifically, each of the first liquid accommodating container 65a and the second liquid accommodating container 65b is disposed such that the distance between an upper end portion (the convex portion 67) and the back surface S2 of the substrate S in the +Z direction is about 3 mm.

The cleaning liquid supply section 66 supplies the cleaning liquid SW to the insides of the first liquid accommodating container 65a and the second liquid accommodating container 65b at any time, thereby making the cleaning liquid SW overflow from the first liquid accommodating container 65a and the second liquid accommodating container 65b. In this way, the cleaning liquid SW which has come into contact with the back surface S2 of the substrate S overflows from the liquid accommodation section 65, thereby being collected by a receiving tray 73 in the cleaner circulation mechanism 64 (described later) which is provided below.

The vibration section 63 includes a plurality of vibrators 63a. In each of the plurality of liquid accommodating containers, the vibration section 63 may include the plurality of vibrators 63a. The plurality of vibrators 63a is disposed on a bottom (an inner surface) 68 of each of the first liquid accommodating container 65a and the second liquid accommodating container 65b along the width direction (the Y direction) intersecting the X direction that is the transport direction of the substrate S.

FIGS. 3A and 3B are diagrams showing the plurality of vibrators 63a disposed on the bottom 68 of the liquid accommodation section 65, wherein FIG. 3A is a perspective configuration diagram and FIG. 3B is a cross-sectional configuration diagram.

Since ultrasonic waves have no dispersibility, in order to favorably propagate the ultrasonic waves into the cleaning liquid SW, positions where the vibrators 63a are disposed are important. As shown in FIG. 3A, the vibrators 63a provided on the bottom 68 of the first liquid accommodating container 65a and the second liquid accommodating container 65b are disposed such that positions in an array direction (the Y direction) are different from each other, and disposed in a staggered form (a staggered array), as shown in FIG. 3B, in the state of a plan view. Further, the vibrators 63a provided on the bottom 68 of the first liquid accommodating container 65a and the second liquid accommodating container 65b are disposed in a state where the respective end portions overlap in a direction (the X direction) intersecting the array direction (the Y direction) in the planes of the bottoms 68, as shown in FIG. 3B.

In this way, if the plurality of vibrators 63a vibrates, the cleaning liquid SW in the first liquid accommodating container 65a and the second liquid accommodating container 65b vibrates due to ultrasonic waves. The frequency of the vibrator 63a is set to be, for example, in a range of 10 K to 100 KHz, whereby foreign matter such as dirt adhered to the substrate S can be favorably removed.

The cleaning liquid SW that overflows from the second liquid accommodating container 65b and the cleaning liquid SW that overflows from the first liquid accommodating container 65a come into contact with the back surface S2 of the substrate S in order and ultrasonic vibrations are applied to the back surface S2 of the substrate S. Since each vibrator 63a is in a state where the end portions partially overlap in the X direction, as described above, seams of ultrasonic vibration areas propagating in the cleaning liquid SW can be eliminated, and thus ultrasonic vibrations can be applied uniformly over the width direction of the substrate S.

Foreign matter adhered to the back surface S2 of the substrate S is reliably removed by contact of the cleaning liquid SW propagating ultrasonic vibrations. Further, in the front surface S1 side of the substrate S, since ultrasonic vibrations are propagated thereto from the back surface S2 side, foreign matter adhered to the front surface S1 is removed.

The second cleaning section 61 includes a cleaning liquid injection section (a liquid supply section) 71 that supplies cleaning liquid to the front surface S1 of the substrate S, and a regulation section 72 that removes the cleaning liquid SW on the substrate S along the width direction (the Y direction) intersecting the transport direction (the +X direction), thereby cleaning the front surface 51 of the substrate S. The cleaning liquid injection section 71 is supplied with the cleaning liquid SW from, for example, the liquid accommodation section 65 (the first liquid accommodating container 65a and the second liquid accommodating container 65b) of the first cleaning section 60. A configuration may also be adopted in which a supply section that supplies the cleaning liquid SW to the cleaning liquid injection section 71 is separately provided.

The cleaning liquid injection section 71 is disposed, for example, on the upstream side (the −X direction) in the transport direction of the substrate S, and the regulation section 72 is disposed on the downstream side (the +X direction) in the transport direction of the substrate S. The cleaning liquid SW supplied to the front surface of the substrate S is transported to the downstream side along with the substrate S and removed along the width direction (the Y direction) from the front surface S1 of the substrate S by the regulation section 72. The regulation section 72 has the same configuration as the cleaning liquid injection section 71 and is made so as to be able to favorably remove the cleaning liquid SW from the substrate by, for example, jetting air or cleaning liquid onto the substrate S. The cleaning liquid SW removed from the substrate S by the regulation section 72 is collected by a receiving tray (described later) which is provided below. As the regulation section 72, a squeegee or the like that regulates the flow of the cleaning liquid SW by coming into contact with the front surface S1 of the substrate S can be used.

The cleaner circulation mechanism 64 includes the receiving tray 73 that receives the cleaning liquid SW that overflows from the liquid accommodation section 65 (the first liquid accommodating container 65a and the second liquid accommodating container 65b) of the first cleaning section 60 or is removed from the substrate S by the regulation section 72, as described above, and a circulation section 74 that circulates the cleaning liquid SW collected in the receiving tray 73 to the cleaning liquid supply section 62.

The circulation section 74 includes a piping section 75 connecting the receiving tray 73 and the cleaning liquid supply section 62, and a circulation pump 76 that circulates the cleaning liquid SW through the piping section 75. A foreign matter removal filter 77 is provided on the route of the piping section 75. The cleaning liquid SW coming into contact with the back surface S2 of the substrate S or removed from the substrate S by the regulation section 72 contains foreign matter such as dirt. The foreign matter removal filter 77 is for removing such foreign matter that is contained in the cleaning liquid SW. In this way, the cleaning liquid SW with foreign matter removed therefrom is circulated to the cleaning liquid supply section 62, and thus the cleaning liquid SW that does not contain foreign matter is supplied to the back surface S2 and the front surface S1 of the substrate S.

Subsequently, an operation by the substrate treatment apparatus 100 will be described.

In the substrate treatment apparatus 100, the substrate S is carried in the inside through the substrate carrying-in port 111a of the accommodation chamber 111 of the alignment section 110. The alignment section 110 performs positioning (alignment) at a predetermined position with respect to the substrate S carried in the accommodation chamber 111.

The substrate S after alignment is carried in the UV treatment section 120 by the transport mechanism TRP. Specifically, the substrate S is carried in the UV treatment section 120 through the substrate carrying-out port 111b of the alignment section 110 (the accommodation chamber 111) and the substrate carrying-in port 121a of the accommodation chamber 121 in the UV treatment section 120.

In the UV treatment section 120, after the substrate S is carried in the accommodation chamber 121, the substrate carrying-in port 121a and the substrate carrying-out port 121b are blocked. Then, the ultraviolet irradiation section 122 is driven, thereby irradiating the substrate S with ultraviolet rays. In this way, organic matter adhered to the front surface of the substrate S is removed.

The substrate S irradiated with ultraviolet rays is carried in the brush section 130 by the transport mechanism TRP. Specifically, the substrate S is carried in the brush section 130 through the substrate carrying-out port 121b of the UV treatment section 120 (the accommodation chamber 121) and the substrate carrying-in port 132a of the accommodation chamber 132 in the ultrasonic cleaning section 140.

In the ultrasonic cleaning section 140, cleaning treatment of the surfaces of the substrate S is performed by using the first cleaning section 60. In the ultrasonic cleaning section 140, the cleaning liquid supply section 62 is driven, thereby bringing the cleaning liquid SW that overflows from the liquid accommodation section 65 (the first liquid accommodating container 65a and the second liquid accommodating container 65b) into contact with the back surface S2 of the substrate S that is transported by the substrate transport mechanism TRP, as shown in FIG. 2. The cleaning liquid SW that overflows from the liquid accommodation section 65 (the first liquid accommodating container 65a and the second liquid accommodating container 65b) is collected by the receiving tray 73 of the cleaner circulation mechanism 64 and circulated to the liquid accommodation section 65 (the first liquid accommodating container 65a and the second liquid accommodating container 65b). Further, in the ultrasonic cleaning section 140, the vibrators 63a of the vibration section 63 are driven, thereby generating ultrasonic vibrations, whereby the ultrasonic vibrations are applied to the back surface S2 of the substrate S through the cleaning liquid SW.

Since the respective vibrators 63a are disposed on the bottom 68 of the liquid accommodation section 65 (the first liquid accommodating container 65a and the second liquid accommodating container 65b) such that end portions are in a state of partially overlapping in the X direction, as shown in FIG. 3B, seams of ultrasonic vibration areas propagating in the cleaning liquid SW are eliminated, and thus ultrasonic vibrations can be applied uniformly over the width direction of the substrate S.

Accordingly, foreign matter adhered to the back surface S2 of the substrate S is reliably removed by contact with the cleaning liquid SW propagating the ultrasonic vibrations. Further, in the front surface 51 side of the substrate S, since ultrasonic vibrations are propagated thereto from the back surface S2 side, foreign matter adhered to the front surface 51 is removed.

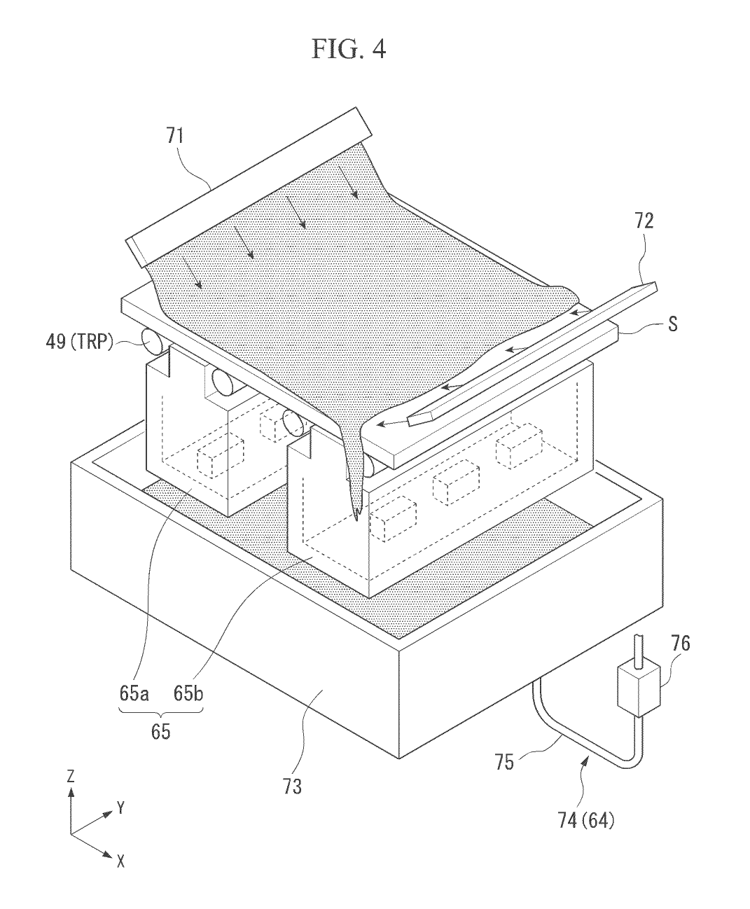

Further, in this embodiment, in a state where ultrasonic vibrations are applied, the ultrasonic cleaning section 140 supplies the cleaning liquid SW from the cleaning liquid injection section 71 of the second cleaning section 61 to the front surface S1 of the substrate S and also removes the cleaning liquid SW from the front surface S1 of the substrate S along the width direction of the substrate S by the regulation section 72, as shown in FIG. 4.

In this manner, in this embodiment, foreign matter adhered to the front surface S1 of the substrate S can be efficiently removed by applying ultrasonic vibrations to the back surface S2 of the substrate S and also supplying the cleaning liquid SW to the front surface S1 by the second cleaning section 61. Used cleaning liquid removed from the substrate S by the regulation section 72 is collected by the receiving tray 73 provided below the substrate S and circulated to the liquid accommodation section 65 (the first liquid accommodating container 65a and the second liquid accommodating container 65b) by the circulation section 74. Since the cleaning liquid SW circulated to the liquid accommodation section 65 (the first liquid accommodating container 65a and the second liquid accommodating container 65b) has been subjected to foreign matter removal by the foreign matter removal filter 77, generation of a defect such as clogging of the liquid accommodation section 65 (the first liquid accommodating container 65a and the second liquid accommodating container 65b) with foreign matter can be prevented.

The substrate S after ultrasonic cleaning is carried in the air knife section 150 by the transport mechanism TRP. Specifically, the substrate S is carried in the air knife section 150 through the substrate carrying-out port 141b of the ultrasonic cleaning section 140 (the accommodation chamber 141) and the substrate carrying-in port 151a of the accommodation chamber 151 in the air knife section 150.

In the air knife section 150, after the substrate S is carried in the accommodation chamber 151, the substrate carrying-in port 151a and the substrate carrying-out port 151b are blocked. Then, the blowing section 152 is driven, thereby jetting air onto the substrate S. In this way, the cleaning liquid adhered to the front surface of the substrate S is completely removed. By the above treatment, initial cleaning treatment in the substrate S is finished.

The substrate S after the treatment by the air knife section 150 is finished is carried out of the substrate treatment apparatus 100 through the substrate carrying-out port 151b and carried into the resist treatment apparatus.

As described above, according to this embodiment, since in a cleaning process by the ultrasonic cleaning section 140, ultrasonic vibrations are applied through the cleaning liquid which comes into contact with the back surface S2 of the substrate S by surface tension and foreign matter peeled from the front surface S1 by the ultrasonic vibrations is removed by the cleaning liquid, it is possible to efficiently perform cleaning treatment by reliably removing foreign matter of the substrate S. Accordingly, it is possible to favorably coat a resist film on the substrate S with foreign matter removed.

The invention is not limited to the above-described embodiment and a change can be appropriately made within a scope which does not depart from the spirit of the invention. For example, in the substrate treatment apparatus 100 described above, as a preceding stage of the ultrasonic cleaning section 140, treatment to jet cleaning liquid along with air to the front surface of the substrate S (hereinafter also referred to as bubble jet (registered trademark) treatment) may also be performed so as to remove fine particles adhered to the front surface of the substrate S, as disclosed in Japanese Unexamined Patent Application, First Publication No. 2007-54695. In this manner, by performing the bubble jet (registered trademark) treatment as a pretreatment of ultrasonic cleaning, it becomes possible to reliably remove foreign matter adhered to the substrate S by UV cleaning, and thus cleanability of the substrate S can be further enhanced. A mechanism that performs the bubble jet (registered trademark) treatment may also be further disposed between the ultrasonic cleaning section 140 and the air knife section 150, and according to this, cleanability of the substrate S can be further enhanced.

Further, in the above-described embodiment, a case where the substrate treatment apparatus 100 is applied at the time of initial cleaning which is performed before the substrate S is carried in a resist coater has been described as an example. However, the substrate treatment apparatus 100 can also be applied to treatment other than the initial cleaning. For example, the substrate treatment apparatus 100 having the ultrasonic cleaning section 140 according to an aspect of the invention can also be applied to pretreatment cleaning when treating a resist film to a substrate with a TFT element or the like formed thereon. In this case, it is preferable to set the number of vibrations of the vibrator 63a in the ultrasonic cleaning section 140 to be a high frequency (specifically, 1 MHz), compared to a case of performing the cleaning before coating described above, and according to this, the TFT element formed on the substrate S can be prevented from being peeled and falling off. Further, in a case of cleaning the substrate S made of an original glass on which a TFT element is not formed, it is preferable to set the number of vibrations of the vibrator 63a in the ultrasonic cleaning section 140 to be in a range of 10 K to 100 KHz.

Further, the substrate treatment apparatus 100 may also be disposed between the respective apparatuses, as in between a wiring formation apparatus which forms a wiring of a TFT element or the like on the front surface of a substrate and a resist coater, so as to clean the substrate S while being transported between the respective apparatuses. In such a case of disposing the substrate treatment apparatus 100 between the respective apparatuses, since foreign matter that adheres to the substrate S is small, a configuration in which the brush section 130 described above is excluded may also be adopted.

Further, in the above-described embodiment, a case where the liquid accommodation section 65 has two liquid accommodating containers, the first liquid accommodating containers 65a and the second liquid accommodating containers 65b, and the vibrators 63a are disposed at different positions by one row in each of the first liquid accommodating containers 65a and the second liquid accommodating containers 65b has been taken as an example. However, the invention is not limited thereto. For example, the vibrators 63a may also be disposed by a plurality of rows with respect to each of the first liquid accommodating containers 65a and the second liquid accommodating containers 65b. Also in this case, it is preferable to make the positions of the vibrators 63a which are disposed on the bottom 68 of the second liquid accommodating containers 65b be different and also create a state where end portions partially overlap in the X direction. According to this, since a state is created where end portions in the respective vibrators 63a partially overlap in the X direction while the number of vibrators 63a is increased, strong ultrasonic vibrations can be applied uniformly over the width direction of the substrate S by eliminating seams of ultrasonic vibration areas propagating in the cleaning liquid SW.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A substrate cleaning apparatus comprising:
a transport section that transports a substrate in a predetermined direction; and
an ultrasonic oscillation section that can clean a front surface side of the substrate by applying ultrasonic waves to a back surface of the substrate which is transported in the predetermined direction by the transport section,
wherein the ultrasonic oscillation section includes a liquid supply section that brings liquid into contact with the back surface of the substrate by surface tension, and a vibrator that applies ultrasonic vibrations to the liquid.

2. The substrate cleaning apparatus according to claim 1, wherein the liquid supply section brings the liquid that overflows from a liquid accommodation section accommodating the liquid into contact with the back surface of the substrate by the ultrasonic vibrations of the vibrator.

3. The substrate cleaning apparatus according to claim 2, wherein the liquid supply section includes a liquid circulation mechanism that circulates the liquid which has come into contact with the substrate to the liquid accommodation section.

4. The substrate cleaning apparatus according to claim 2, wherein the vibrators are respectively disposed on inner surfaces of a plurality of liquid accommodation sections along a width direction intersecting a transport direction of the substrate and disposed such that the respective end portions of the vibrators overlap in a direction intersecting an array direction in a plane of the inner surface.

5. The substrate cleaning apparatus according to claim 2, wherein the vibrators are respectively disposed on inner surfaces of a plurality of liquid accommodation sections along a width direction intersecting a transport direction of the substrate and disposed such that the respective end portions of the vibrators come into contact with each other in a direction intersecting an array direction in a plane of the inner surface.

6. The substrate cleaning apparatus according to claim 1, wherein the liquid supply section brings the liquid into contact with the entire area in a width direction intersecting a transport direction of the substrate.

7. The substrate cleaning apparatus according to claim 1, further comprising:
a front surface side cleaning section that cleans a front surface of the substrate by supplying cleaning liquid to a front surface side of the substrate and also removing the cleaning liquid along a direction intersecting a transport direction of the substrate.

8. The substrate cleaning apparatus according to claim 7, wherein the front surface side cleaning section includes a cleaning liquid supply section that supplies the cleaning liquid, and a regulation section that removes the cleaning liquid from the substrate by regulating flow of the cleaning liquid along a direction intersecting the transport direction.

9. A substrate cleaning apparatus comprising:
a transport section that transports a substrate in a predetermined direction; and
a front surface side cleaning section that cleans a front surface of the substrate by supplying cleaning liquid to a front surface side of the substrate and also removing the cleaning liquid along a direction intersecting a transport direction of the substrate.

10. The substrate cleaning apparatus according to claim 9, wherein the front surface side cleaning section includes a cleaning liquid supply section that supplies the cleaning liquid, and a regulation section that removes the cleaning liquid from the substrate by regulating flow of the cleaning liquid along a direction intersecting the transport direction.

11. The substrate cleaning apparatus according to claim 9, further comprising:
an ultrasonic oscillation section that can clean the front surface side of the substrate by applying ultrasonic waves to a back surface of the substrate in which cleaning is performed by the front surface side cleaning section while being transported in the predetermined direction by the transport section,
wherein the ultrasonic oscillation section includes a liquid supply section that brings liquid into contact with the back surface of the substrate by surface tension, and a vibrator that applies ultrasonic vibrations to the liquid.

12. The substrate cleaning apparatus according to claim 11, wherein the liquid supply section brings the liquid that overflows from a liquid accommodation section accommodating the liquid into contact with the back surface of the substrate by the ultrasonic vibrations of the vibrator.

13. The substrate cleaning apparatus according to claim 12, wherein the liquid supply section includes a liquid circulation mechanism that circulates the liquid which has come into contact with the substrate to the liquid accommodation section.

14. The substrate cleaning apparatus according to claim 12, wherein a plurality of vibrators is provided on an inner surface of the liquid accommodation section along a width direction intersecting a transport direction of the substrate, and adjacent vibrators are disposed such that the respective end portions of the plurality of vibrators overlap in a direction intersecting an array direction in a plane of the inner surface.

15. The substrate cleaning apparatus according to claim 12, wherein a plurality of vibrators is provided on an inner surface of the liquid accommodation section along a width direction intersecting a transport direction of the substrate, and adjacent vibrators are disposed such that the respective end portions of the plurality of vibrators come into contact with each other in a direction intersecting an array direction in a plane of the inner surface.

16. The substrate cleaning apparatus according to claim 11, wherein the liquid supply section brings the liquid into contact with the entire area in a width direction intersecting a transport direction of the substrate.
